(19) United States
(12) Patent Application Publication
(10) Pub. No.: US 2003/0145480 A1
(43) Pub. Date: Aug. 7, 2003

(54) Cellular phones

(76) Inventor: Tomohiro Endo, Osaka (JP)

Correspondence Address: Richard M. Goldberg, Suite 419, 25 East Salem Street, Hackensack, NJ, 07601, US

(21) Appl. No.: 10/118,186

(22) Filed: Apr. 8, 2002

(30) Foreign Application Priority Data
Feb. 1, 2002 (JP) 025880/2002

(51) Int. Cl. G01B 3/10

(52) U.S. Cl. 33/760

(57) ABSTRACT

There are provided constitutions of improved cellular phones that can be utilized for various purposes; wherein the cellular phones each have a cord or tape tied externally thereto, and the cord or tape has scale marks enabling measurement of the length of things, thus realizing diversified exploitation of the phone.

### BACKGROUND OF THE INVENTION

The present invention relates to constitutions of cellular phones each having a cord or a tape tied thereto.

The applicant had already filed Patent Application Nos. 144877/1999, 145290/1999 and 316877/1999 with the Japanese Patent Office for constitutions of cellular phones each having a length-adjustable cord tied thereto.

The improved cellular phones disclosed in the above Patent Applications are convenient in that the position of the cord or the length thereof can be adjusted depending on whether the cellular phone is used or not.

However, in such a cellular phone with a cord, the cord merely has an action of hanging the phone, and there is no essential technical idea in it to allow the cord to exhibit positively other functions.

It is an objective of the present invention to provide, in view of the circumstances of the prior art, constitutions of improved cellular phones enabling measurement of the length of objects.

### SUMMARY OF THE INVENTION

In order to solve the problem described above, the present invention relates to constitutions of improved cellular phones each having a cord or a tape tied externally thereto, wherein the cord or the tape is provided with scale marks enabling measuring of length.

Other aspects and advantages of the invention will become apparent from the following description, taken in conjunction with the accompanying drawings illustrated by way of examples the principles of the invention.

### BRIEF DESCRIPTION OF THE DRAWING

The features of the present invention that are believed to be novel are set forth with particularity in the appended claims. The invention together with the objects and advantages thereof, may best be understood by reference to the following description of the presently preferred embodiments together with the accompanying drawings in which:

FIG. 1(a) is a partly cross-sectional front view showing a constitution of the cellular phone according to a first embodiment of the present invention having an external winder;

FIG. 1(b) is a partly cross-sectional front view showing a constitution of the cellular phone according to the first embodiment having an internal winder;

FIG. 2(a) is a front view showing a constitution of the cellular phone according to a second embodiment of the present invention having an external slit;

FIG. 2(b) is a front view showing a constitution of the cellular phone according to the second embodiment having an external pole; and

FIG. 3 shows in front views basic constitutions of the present invention.

### DETAILED DESCRIPTION OF THE INVENTION

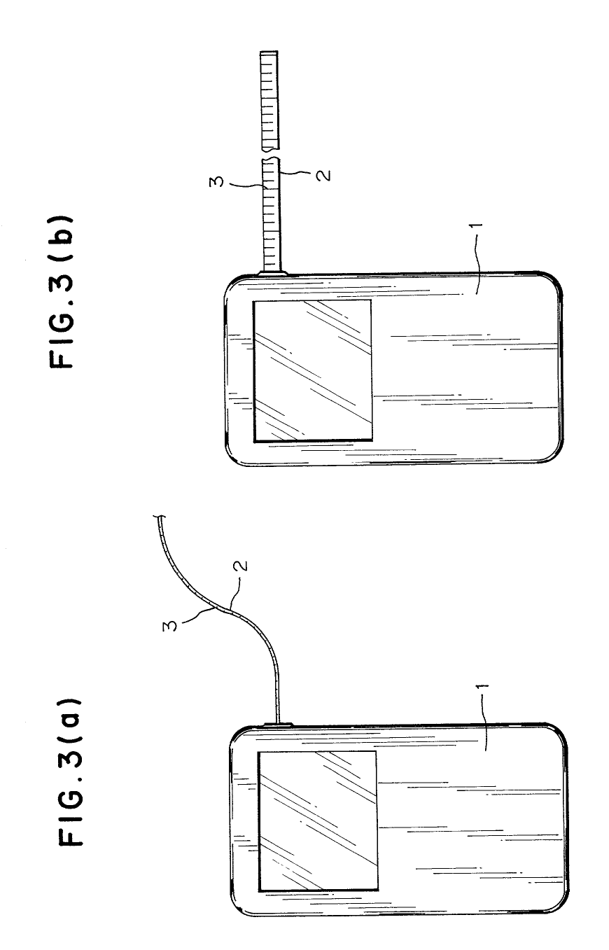

FIG. 3 shows basic constitutions of the present invention, in which a cellular phone 1 has a cord 2 (in FIG. 3(a)) or a tape 2 (in FIG. 3(b)) tied externally thereto, wherein the code and the tape have scale marks 3 enabling measurement of length like a tape measure.

Thus, the cellular phone of the present invention can be used, for example, in site work where one can communicate with others with the phone while carrying out, as necessary, measurement of distance or dimensions using the cord or tape 2 tied to the phone, realizing diversified exploitation of the cellular phone.

The method of applying scale marks 3 to the cord or tape 2 is not particularly limited. For example, scale marks 3 may be formed by printing or by arranging paint or ink dots or lines at regular intervals on a plane and pressing the cord or tape 2 against the plane.

Particularly when a fluorescent paint is used for forming the scale marks 3, it enables measurement of distance or dimensions even in the darkness of night, which is very convenient.

Meanwhile, if a clip and the like is attached to or around the tail end of the cord or tape 2, the cellular phone can be fastened to one's pocket therewith, preventing the phone from falling down from the pocket, which is extremely convenient.

The, present invention will now be described below by way of embodiments.

### Embodiment 1

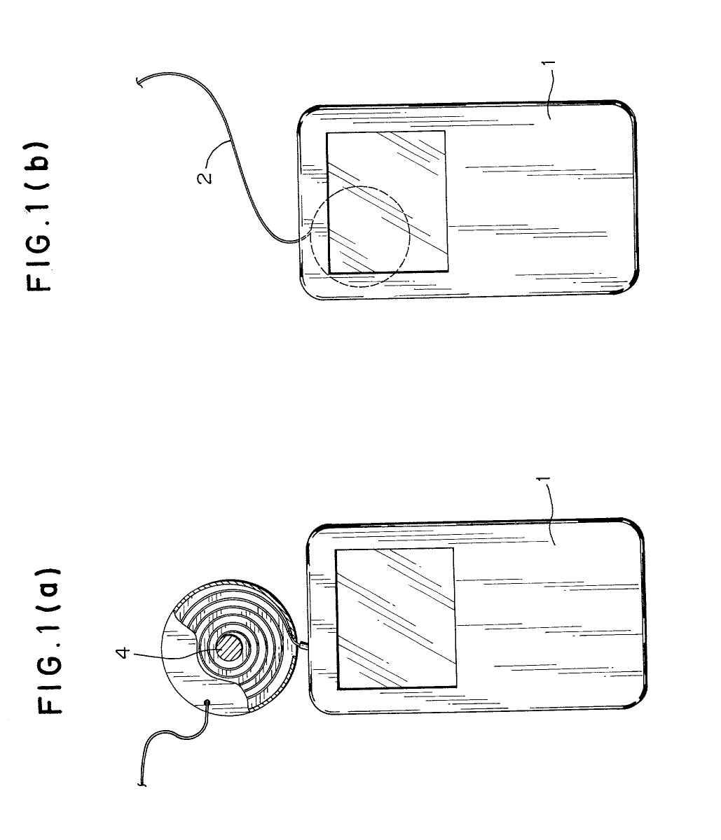

In a first embodiment of the present invention, as shown in FIG. 1, the cellular phone 1 has a winder 4, capable of taking up the cord or tape 2 thereon, on the external side (in FIG. 1(a)) or inside (FIG. 1(b))(FIGS. 1(a) and 1(b) both showing the cases where cords 2 are used).

The presence of such a winder 4 enables use of a necessary length of cord or tape 2 with scale marks 3, realizing long distance measurement.

### Embodiment 2

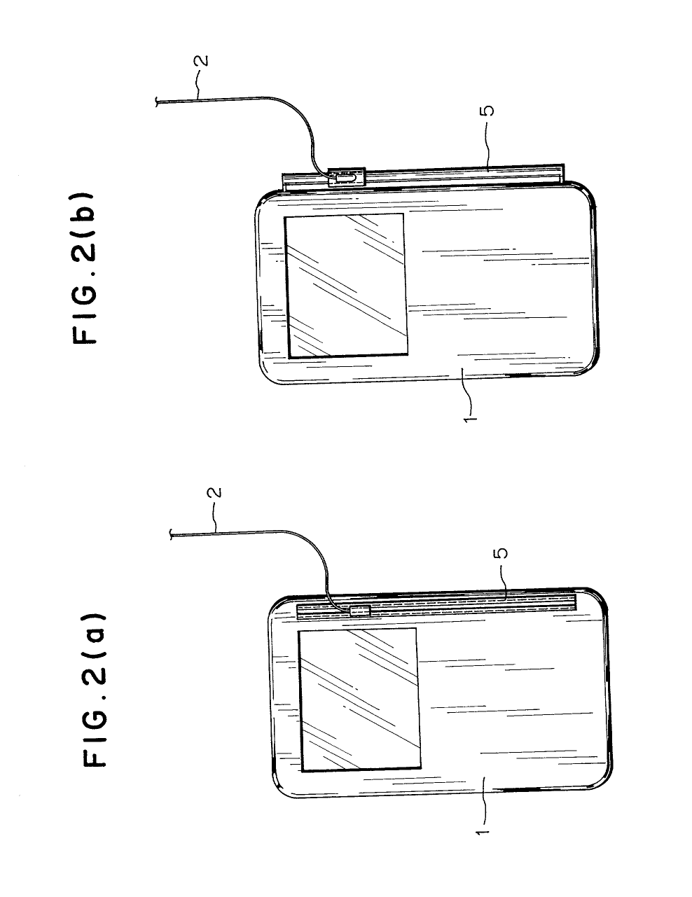

In a second embodiment, as shown in FIG. 2, the tail end of the cord or tapa 2 or around it is slidably engaged with a slit 5 (in FIG. 2(a)) or with a pole 5 (in FIG. 2(b)) formed inside the cellular phone or on the external side (FIGS. 2(a) and 2(b) both show the cases where the slit and pole are provided on the external side of the phone).

The second embodiment described above is extremely convenient in that the cellular phone need not necessarily be moved when the cord or tape 2 is moved for measurement (FIGS. 2(a) and 2(b) show the cases where the slit and pole are provided on the external side of the phone).

In the present invention described above, the cellular phone can be utilized not only for communication with others but also for measurement of distance or dimensions, enabling diversified exploitation of the phone in site works or clerical works.

As described above, the present invention having realized absolutely new usage of cellular phone finds immeasurable values.

It should be apparent to those skilled in the art that the present invention may be embodied in many other specific forms without departing from the spirit or scope of the invention.

What is claimed is:

1. An improved cellular phone comprising a cord or a tape tied externally thereto, the cord or tape having scale marks enabling measurement of length.

2. The improved cellular phone according to claim 1, wherein the cord or tape has at or around its tail end a clipping device.

3. The improved cellular phone according to claim 1, wherein the scale marks are applied using a fluorescent paint.

4. The improved cellular phone according to claim 1, further comprising a cord or tape winder located inside or on the external side of the cellular phone.

5. The improved cellular phone according to claim 1, wherein the proximal end of the cord or tape or a portion around it is engaged slidably with a slit or a pole provided inside or on the external side of the cellular phone.
